(19) United States
(12) Patent Application Publication
(10) Pub. No.: US 2016/0275267 A1
(43) Pub. Date: Sep. 22, 2016

(54) SLEEP MASK GAMIFICATION

(71) Applicant: KONINKLIJKE PHILIPS N.V., Eindhoven (NL)

(72) Inventors: Julian Charles NOLAN, Pully (CH); Matthew John LAWRENSON, Bussigny-pres-de-lausanne (CH)

(21) Appl. No.: 15/035,617

(22) PCT Filed: Nov. 24, 2014
(86) PCT No.: PCT/EP2014/075347

§ 371 Date: May 10, 2016

(30) Foreign Application Priority Data
Nov. 26, 2013 (EP) 13194421.7

(51) Int. Cl. G06F 19/00

(52) U.S. Cl. CPC G06F 19/3481

(57) ABSTRACT

The present invention relates to a therapy support system (22) for improving the compliance of a patient (10) using a therapeutic device (12), comprising: a data interface (24) for receiving at least one device parameter value (32) of a first patient (10) indicative of a therapeutic device usage of the first patient (10); a target unit (26) for determining or receiving at least one individual target (34) indicative of a targeted usage of the first patient (10); a gamification unit (28) for determining an individual performance indicator (36) based on the at least one device parameter value (32) and the at least one individual target (34), said individual performance indicator (36) being indicative of a success of the first patient (10) in reaching the at least one individual target (34), said gamification unit (28) being further configured to determine based on said individual performance indicator (36) feedback information (38) including an assessment of the first patient's (10) perspective of reaching the at least one individual target (34); and a feedback unit (30) for providing the feedback information (38) to the first patient (10). The present invention further relates to a corresponding method as well as to a pressure support system to be used in combination with said therapy support system (22).

### FIELD OF THE INVENTION

The present invention relates to a therapy support system and a corresponding method for improving the compliance of a patient using a therapeutic device. The present invention further relates to a pressure support system for being used in combination with such a therapy support system.

### BACKGROUND OF THE INVENTION

Obstructive Sleep Apnea (OSA) refers to a sleep disorder usually caused by an obstruction or partial obstruction of the upper airway and a restriction of the air passage into the lungs. It is characterized by repetitive pauses in breathing or instances of shallow and infrequent breathing during sleep and it is usually associated with a reduction in blood oxygen saturation. Such pauses in breathing, called apneas, typically last 20 to 40 seconds. Less severe but also often causing a decreased amount of air movement into the lungs and a drop in oxygen level in the blood are episodes of overly shallow breathing or an abnormally low respiratory rate, called hypopnea. The obstruction of the upper airway is usually caused by reduced muscle tonus of the body that occurs during sleep. The human airway is composed of walls of soft tissue which can collapse and thereby obstruct breathing during sleep. Tongue tissue moves towards the back of the throat during sleep and thereby blocks the air passages. OSA is therefore commonly accompanied by snoring.

Different invasive and non-invasive treatments for OSA are known. One of the most powerful non-invasive treatments is the usage of continuous positive airway pressure (CPAP) or bilevel positive airway pressure (BiPAP) in which the patient uses a pressure support system (CPAP machine or BiPAP machine) that blows cleaned air, oxygen or any modification thereof in a pressurized or unpressurized way through the airway of the patient in order to keep it open. One problem of the use of a pressure support system is, however, that the therapy is often disagreeable for the patient, which frequently results in a bad patient compliance. If, however, the patient does not regularly use his pressure support system, the outcome of the therapy may be endangered.

Such a compliance problem also exists with other therapeutic devices used by patients suffering from other diseases.

One approach to improve patient compliance is to make use of social interaction, e.g. interaction among patients or interaction between patients and their relatives, in order to increase the compliance.

In WO 2012/127337 A2 methods and systems to promote targeted inter-patient interactions to increase patient adherence are presented. It is outlined that inter-patient networks, in particular virtual environments such as an online forum, may foster a sense of community and help promote user adherence to a (positive airway pressure) therapy regimen, despite various practical limitations. Systems and methods are provided to alleviate such limitations by providing a virtual environment in which users are matched (anonymously) in pairs or groups based on usage information of their respective therapeutic devices.

WO 2010/141957 A2 discloses a system for monitoring of and managing compliance with treatment for obstructive sleep apnea using oral appliance therapy. The system comprises a sensor module installed in an oral appliance, a data communications facility for communicating with the oral appliance, a control module, and a central database for storing data. Data stored on the sensor module is transferred to the data communications facility for local storage. The control module validates the locally stored temperature data and uploads the validated data into the central database. Temperature data stored in the central database may be viewed remotely via a secure computer network connection in graphical form by authorized users using role-based access controls. Authorized users may include the patient, the patient's provider, system administrators, and stake holders including insurance carriers providing medical coverage for OAT.

However, a lack of patient compliance when using therapeutic devices is still a problem.

### SUMMARY OF THE INVENTION

It is an object of the present invention to provide a therapy support system and a corresponding method for improving the compliance of a patient using a therapeutic device. It is further an object of the present invention to provide a pressure support system to be used in combination with said therapy support system.

According to a first aspect of the present invention, there is provided a medical information system for improving the compliance of a patient using a therapeutic device, comprising: a data interface for receiving at least one device parameter value of a first patient indicative of a therapeutic device usage of the first patient; a target unit for determining or receiving at least one individual target indicative of a targeted therapeutic device usage of the first patient; a gamification unit for determining an individual performance indicator based on the at least one device parameter value and the at least one individual target, said individual performance indicator being indicative of a success of the first patient in reaching the at least one individual target, said gamification unit being further configured to determine based on said individual performance indicator feedback information including an assessment of the first patient's perspective of reaching the at least one individual target; and a feedback unit for providing the feedback information to the first patient.

According to another aspect of the present invention, there is provided a therapy support method for improving the compliance of a patient using a therapeutic device, comprising the steps of: receiving at least one device parameter value of a first patient indicative of a therapeutic device usage of the first patient; determining or receiving at least one individual target indicative of a targeted therapeutic device usage of the first patient; determining an individual performance indicator based on the at least one device parameter value and the at least one individual target, said individual performance indicator being indicative of a success of the first patient in reaching the at least one individual target; determining based on said individual performance indicator feedback information including an assessment of the first patient's perspective of reaching the at least one individual target; and providing the feedback information to the first patient.

According to yet another aspect, there is provided a pressure support system comprising: a pressure generator for generating a pressurized flow of breathable gas; a patient interface for delivering the pressurized flow of breathable gas to the patient; a sensor for acquiring a device parameter value; and a therapy support system interface for providing the device parameter value to a therapy support system as outlined above.

In yet further aspects of the present invention, there are provided a computer program which comprises program code means for causing a computer to perform the steps of the method disclosed herein when said computer program is carried out on a computer as well as a non-transitory computer-readable recording medium that stores therein a computer program product, which, when executed by a processor, causes the method disclosed herein to be performed.

Preferred embodiments of the invention are defined in the dependent claims. It shall be understood that the claimed method and computer program have similar and/or identical preferred embodiments as the claimed system and as defined in the dependent claims.

The basic idea of the present invention includes using gamification techniques in order to increase patient compliance of a patient using a therapeutic device, in particular a PAP machine. Gamification techniques rely on a user's natural desire for competition, achievement, status, self-expression, altruism and closure. Using gamification techniques is becoming more and more popular in a range of consumer facing interfaces, e.g., being commonly featured as part of advertising campaigns. It is proposed herein to apply gamification techniques to assist users in using a therapeutic device, in particular in wearing a patient interface of a pressure support system, e.g. a mask of a PAP machine.

In particular with pressure support systems but also with other therapeutic devices, the provided therapy is sometimes disagreeable for the patient using the therapeutic device. Although a patient often accepts the necessity of the provided therapy, it frequently happens that the patient finds excuses for not using his therapeutic device as originally prescribed by his physician in the form of a therapy plan or the like. The patient finds excuses for not using the device every day or for using it with lower intensity, etc. The patient is not compliant with his therapy. In order to overcome this problem and to improve the compliance of a patient using a therapeutic device, the present invention proposes to use gamification techniques as part of the therapy. Thereby the therapy and the behavior of the patient using the therapeutic device are interpreted as a game in which the patient is challenged to reach a target. This target is usually defined such that it corresponds to an intended therapy behavior or therapeutic device usage of the patient as defined by the patient himself or, preferably, by the patients physician or care provider. Such a challenge increases the patient's motivation to win the game (or perform well in the game) by complying with the prescribed therapy.

The presented system comprises a data interface over which device parameter values are received. These device parameter values are indicative of a therapeutic device usage of a patient, i.e. how the patient uses a therapeutic device. Different device parameters describe how a therapeutic device can be used, i.e. operated. The received device parameter values describe how the device is actually used by the patient (or has been used). Device parameters may particularly be measured by means of sensors or may be determined by the patient himself or by medical support personnel. On the one hand, the received device parameters may correspond to device settings or device configuration as chosen by the user or by medical support personnel. Examples may include a chosen pressure of a PAP machine, an operation frequency or intensity or the like. On the other hand, the device parameter values may also correspond to information on how the patient uses or has used the device (e.g. how often, how long etc.). Device parameter values may include values on an absolute scale (e.g. 1-10 representing the choice of an operation mode), a relative scale (e.g. percentage of a maximum intensity, percentage of time, etc.) or measured values on a predefined scale (hours, millibars, milliliters, millimeters etc.). These device parameter values can be measured and provided manually (e.g. by the patient himself or by medical support personnel) or measured and/or provided automatically i.e. directly from a suitable sensor, e.g. in a separate sensing system or integrated in the therapeutic device.

In the target unit at least one individual target is determined or received. An individual target may particularly correspond to a device parameter. For instance, a device parameter may be the time a patient uses his device and a corresponding target may be a minimum usage time of a certain number of hours. In this example, the received device parameter value corresponds to the actual time the patient uses or has used his therapeutic device. Device parameter value and individual target are thus indicated on the same scale in this example. Thereby the individual target may correspond to one single device parameter or to a function of multiple (different) device parameters. It may also be possible that an individual target corresponds to a value being determined based on multiple device parameters (e.g. the cumulated time the device has been used during the last week).

The individual target is indicative of a targeted therapeutic device usage of the patient, i.e. how the patient should use the device (therapy plan). It may thereby be possible that the patient himself or any medical support personnel (physician, caretaker, etc.) defines how the patient should use the therapeutic device. Then the target unit receives the at least one individual target itself or any kind of basic information based on which it may determine the individual target. It may, however, also be possible that the target unit determines a target by, e.g., updating a previously defined target, by increasing a previous target or by calculating a function of a currently obtained device parameter value, etc. Examples for individual targets may include an apnea hypopnea index (AHI), a parameter being indicative of the pressure of a flow of pressurized gas or a parameter being indicative of a duration the patient's use of the therapeutic device. If the target includes a point in time, the target may correspond to a short term or long term target indicating the time period the patient may use to reach the target.

The system according to the present invention further comprises a gamification unit. Therein, an individual performance indicator is determined to measure the performance or success of the patient in reaching his at least one individual target. The gamification approach herein consists in interpreting the patient's therapy as a game or challenge wherein it is the goal to reach the individual target. A good performance, i.e. a high performance indicator, means that the patient reaches his target or comes close to reaching his target. In other words, the performance indicator may denote the chance or the likelihood that the patient reaches the individual target. Thereby the performance indicator can be a binary value (yes/no) or also a value indicated on an absolute or relative scale (1-10, percent, etc.). The determination of the performance indicator may include any function or calculation based on the received device parameter and the individual target. Depending on the definition of the individual target (i.e. whether the target includes a point in time or not), the performance indicator may be indicative of the long or short term performance in the challenge to reach the corresponding individual target, i.e. use his therapeutic device in a way that corresponds to the targeted therapeutic device usage.

Further, feedback information is determined in the gamification unit. This feedback information can particularly be determined based on the individual performance indicator. This feedback information is indicative of how likely it is that the patient will reach his individual target. The feedback information thus preferably includes time-based information (e.g. how much time remains until the target needs to be reached, how much time has expired so far, etc.). If, e.g., a patient is trying to reach an individual target that corresponds to a certain total use time of a therapeutic device during one day and his current performance is 50% meaning that he has already fulfilled half of this individual target, then it depends on how much time he has left if his perspective of reaching the target is to be assessed. If he has only little time left, the feedback information may include a statement indicating that it is unlikely that he reaches his individual target. If however, he has a lot of time left, then he may receive positive feedback information indicating that he is on a good way to reaching his individual target. On one hand, it may be possible that the feedback information basically corresponds to the performance indicator itself, i.e. the patient is provided with his (current) individual performance indicator. On the other hand, it is possible that the feedback information is determined based on the individual performance indicator, e.g. by applying a mathematical function or by including additional information, such as the remaining time until the individual target has to be reached, the trend in the performance, etc. Then the feedback information basically corresponds to a projection of how likely it is that the patient will reach his individual target.

The feedback information is provided to the patient via a feedback unit. Such a feedback unit may particularly correspond to any data representation or communication equipment, e.g. a display or a network/internet/wireless interface or the like.

In comparison to previous approaches the present invention thus treats the therapy of a patient as a game or challenge where a performance of the patient is determined. The patient is constantly, upon request or on a regular basis (e.g. each morning) provided with feedback information on his performance (assessing his performance) and on how likely it is that he reaches his individual target. Thereby, the patient's desire for competition is stimulated and he is motivated to comply with the therapy as described by the individual target (targeted therapeutic device usage). Thus, it is aimed at increasing compliance by making use of the natural desire to be successful in a competition and to reach a target.

WO 2010/141957 A2 fails to disclose a target unit for determining or receiving at least one individual target indicative of a targeted therapeutic device usage of the patient. In fact, WO 2010/141957 A2 compares the temperature data against “compliance parameters” associated with the oral appliance, wherein said compliance parameters include a compliance standard. The compliance parameters mentioned in WO 2010/141957 A2 are therefore standard values and may thus not be compared with the “at least one individual target” that is determined or received by means of the target unit according to the present invention. Even more important is that WO 2010/141957 A2 proposes a simple comparison of a time the oral appliance was used by the patient to a standard compliance value. The present invention, however, makes use of a gamification unit that is configured to determine an individual performance indicator that is indicative of a success of the patient in reaching the at least one individual target. The gamification unit according to the present invention is further configured to determine based on said individual performance indicator feedback information including an assessment of the patient's perspective of reaching the at least one individual target. The therapy support system according to the present invention does therefore not only compare the status quo of the therapy device usage to a standard value, but makes a forecast how likely it is that the patient reaches his individual target that has been set before by means of the target unit.

WO 2012/127337 A2 discloses a system that is trying to increase patient adherence to a therapeutic device. This system has insofar a similar aim as the therapy support system according to the present invention. However, WO 2012/127337 A2 uses a different kind of approach to promote user adherence. WO 2012/127337 A2 is mainly focusing on comparing a first patient's device usage with the device usage of other patients. It provides an inter-patient network that allows patients to compare their usages of their therapeutic devices. The system of WO 2012/127337 A2 also allows ranking the different users according to their usage of and compliance with their therapeutic devices. However, WO 2012/127337 A2 fails to disclose the possibility to set individual targets for each of the patients. WO 2012/127337 A2 therefore also fails to disclose a target unit as defined in claim 1. The gamification module proposed in WO 2012/127337 A2 may also not be compared to the gamification unit according to the present invention. The gamification module described in WO 2012/127337 A2 only gathers interaction information from different kind of users and ranks them based on “a user's therapy rank and/or experience rank”, i.e. based on how often and to what extent each user uses his therapeutic device. An individual performance indicator as proposed by the present invention that includes a forecast assessment of how likely it is that the patient will reach his individual target is not disclosed in WO 2012/127337 A2.

A further advantage resulting from the feedback unit is that the patient is confronted with the impact of his current therapeutic device usage (as indicated by the at least on device parameter value). The patient may obtain instant feedback on how his current therapeutic device usage affects his game performance. By assessing his perspective of reaching the individual target and providing this assessment to him in form of feedback information, the patient directly obtains feedback on the effect of his therapeutic device usage on his performance. By providing such feedback information, the patient may better understand how his therapeutic device usage (as indicated by the at least one device parameter value) affects the outcome or success of his therapy. This knowledge increases his motivation to comply with the desired or suitable therapeutic device usage (as indicated by the at least one individual target).

According to a first embodiment of the therapy support system the data interface is configured to further receive at least one device parameter value of at least one further patient; the target unit is configured to further determine or receive at least one group target indicative of a targeted therapeutic device usage of a patient group including the first patient and at least one of the at least one further patient; the gamification unit is configured to further determine a group performance indicator based on the at least one device parameter value of the patient group and the at least one group target, said group performance indicator being indicative of a success of the patient group in reaching the at least one group target; and the feedback information further includes an assessment of the patient group's perspective of reaching the at least one group target based on the group performance indicator.

Thus, in addition to challenging the patient to reach his individual target by gamifying his therapy or therapeutic device usage, a social interaction component is added by also including other patients in the game. The patient is not only challenged to reach his individual target but also to contribute to a group target that has to be achieved by him in collaboration with other patients. Thereby a group target may correspond to a cumulated target, i.e. a single target to which different patient can equally contribute (e.g. a total time that all the patients should cumulatively use their therapeutic devices). Such a group target may particularly be determined based on the individual targets of the different patients in the patient group. A group target may also correspond to a concatenation of individual targets of the different patients in the patient group, i.e. the group target is fulfilled if every patient fulfills his individual target or one of his at least one individual target. It may be possible that the individual targets of different patients need to be scaled and/or normalized in order to allow a meaningful comparison and/or group target determination.

In addition to the individual performance indicator there is then also determined a group performance indicator indicating how well the patient group performs, i.e. how successful the patient group is in reaching the at least one group target. The feedback provided to the patient is then based on his individual performance and also on the performance of his group.

One advantage of defining, i.e. receiving or determining, at least one group target in addition to an individual target is that social interaction between the patients in the patient group can be stimulated or fostered. If, e.g., the success or the group performance of the group is bad (e.g. the feedback information indicates that the patient group is likely to not reach the group target) because one patient in the group has failed to fulfill his individual goal or to contribute his share to the group target, then the other patients in the group may try to convince him to contribute, i.e. use his therapeutic device as indicated by the targeted therapeutic device usage of the patient group (and as originally defined by a physician based on a therapy plan). One the one hand the group bond, i.e. the feeling of belonging to a team, can help to increase the patient's motivation to use his therapeutic device accordingly. On the other hand social interaction, e.g. by means of a social network or other communication possibilities, may allow a direct surveillance of one patient by other patients and possibly result in a sort of peer pressure on an incompliant patient and/or encourage mutual help and assistance.

According to another embodiment, the therapy support system further comprises: a medical database interface for obtaining profile data of the first patient and the at least one further patient, said profile data including information on at least one of medical history, therapeutic device usage period, medication, age, weight, height and sex of said patients; a group determination unit for determining the patient group based on a comparison of the profile data of the first patient with the profile data of the at least one further patient.

It may particularly be advantageous to group patients into a patient group that has a comparable background. If, e.g., patients starting their therapy at the same time or using the same therapeutic devices are grouped, this may foster their interaction. An advantage may be that the individual targets of patients that are comparable with respect to their profile data may easily and efficiently be combined into a concatenated group target as it is likely that the individual targets are comparable with respect to the time frame, units etc.

In another preferred embodiment, the gamification unit is configured to determine the individual performance indicator based on: a difference between the at least one device parameter value and the at least one individual target; a function of said difference; or a look-up table including individual performance indicators for different values of said difference.

One obvious way to determining the individual performance (or also the group performance) is to make use of the current difference between the actual device parameter value and the corresponding targeted or desired value for this device parameter as specified in the individual (or group) target. The (individual or group) performance indicator then corresponds to how close the patient (or also the patient group) comes to reaching the target.

In yet another preferred embodiment the gamification unit is further configured to determine if an insufficient individual progress criterion is fulfilled, said insufficient individual progress criterion particularly being fulfilled if the individual performance indicator is below a tolerable individual backlog threshold; and the feedback unit is configured to provide the feedback information to the first patient and/or to at least one further patient if the insufficient individual progress criterion is fulfilled.

In particular, the feedback information may be provided if or as soon as the patient runs at risk of not reaching the individual target as indicated by a certain criterion (performance indicator is below a tolerable individual backlog threshold). Thus, alternatively to providing the feedback information constantly, upon request or on a regular basis, the feedback information is only provided upon a trigger event, if the backlog is high (or too high). Such triggered feedback information may also trigger a reaction of the patient and motivate him to increase his effort to still try to reach his individual target. It may thus particularly be useful to define a tolerable individual backlog threshold in a way that the target can still be reached if the patient immediately adapts his therapeutic device use. The provision of feedback information may then again appeal to the patient's desire for challenge and result in an improved compliance with a targeted therapy. It may be possible that a physician or care provider defines or predefines a suitable individual backlog threshold or that such a threshold is automatically determined in the gamification unit based on the individual performance indicator and the individual goal (e.g. a percentage value).

Alternatively or additionally, providing the feedback information not only to the patient but also to another patient (at least one further patient) or also to other people (e.g. patients being organized in a social network platform, the patient's relatives or physician, etc.) may also present a way to further increase the motivation of the patient. A patient knowing that information on his performance in the challenge to meet his individual target (feedback information) is shared with other patients (or also any other people) may fear to be exposed for bad performance and increase his effort to reach his individual target. This again may be another incentive to comply with his therapy plan (as indicated by the individual and/or group targets). Also social interaction may be fostered.

In a preferred embodiment the feedback unit is configured to further provide at least part of the feedback information to the patient group.

It may particularly be interesting to provide the feedback information to the patient group, i.e. the other patients that contribute to the group target and that are actually affected by the behavior of the patient. One advantage is that the patients in the patient group have a comparable background and know of the difficulties of complying with the therapy. The other patients in the patient group may therefor better understand the actual content of the feedback information. If a patient is provided with feedback information on how one his peers in the patient group performs, he can communicate with this peer based on this information. For instance, if a patient receives feedback information that he will not reach his individual goal and/or contribute his share to the group target, and this feedback information is shared with other patients in the patient group, the other patients in the patient group may communicate with this patient and try to motivate him to improve his performance.

In yet another preferred embodiment the gamification unit is further configured to determine whether an insufficient group progress criterion is fulfilled, said insufficient group progress criterion particularly being fulfilled if the group performance indicator is below a tolerable group backlog threshold; and the feedback unit is configured to provide the feedback information to the first patient and/or to provide at least part of the feedback information to the patient group if the insufficient group progress criterion is fulfilled.

Comparable to the insufficient individual progress criterion an insufficient group progress criterion may be used for triggering the provision of feedback information to the group. If the group runs at risk of not reaching the group target, the group is informed. As a result therefrom, social interaction may be provoked and/or the patients in the patient group may increase their effort to reach their individual target or contribute their share to a group target. As explained above, a patient knowing that other patients in his patient group also contribute to a combined group performance may be motivated to increase his own effort or to communicate with his peer patients to motivate them to increase their effort. Therefor the feedback information or at least part of it may preferably be provided to the patient group. Analogously to the individual backlog threshold the group backlog threshold may also be defined by a physician or caretaker or determined automatically. An advantage of providing the feedback information upon a trigger event is that the patients may become used to adjust their therapy upon the reception of feedback information.

According to another preferred embodiment the gamification unit is further configured to determine whether an individual reward criterion is fulfilled, said individual reward criterion particularly being fulfilled if the individual performance indicator indicates that the at least one device parameter value meets the at least one individual target; and the feedback unit is further configured to provide a reward to the first patient if the individual reward criterion is fulfilled.

Alternatively or additionally to merely providing feedback information including an assessment of how likely it is that the patient will reach his target, there may also be provided a reward. Such a reward particularly corresponds to any piece of information or tangible impact on the patient's situation. In particular, a reward may appeal to the patient's pride for having fulfilled the individual reward criterion. Examples for rewards may include a graph of the patient's performance in reaching one or more targets, a nice icon congratulating him for fulfilling the individual reward criterion or a status he has achieved or the like. A reward may also correspond to a text or other message provided to other patients, relatives or medical support personnel perhaps including the new status of the patient relying on social interaction provided by the informed persons. A reward may also relate to more tangible effects such as an alleviation of a probably unpleasant therapy of the patient or an unlocking of further functionality of the therapeutic device used by the first patient. By providing a reward, the patient may be given a concrete objective. A patient wanting to obtain this reward may have yet another incentive of being compliant with a prescribed therapy, i.e. reach his at least one individual target.

According to another preferred embodiment, the gamification unit is further configured to determine whether a group reward criterion is fulfilled, said group reward criterion particularly being fulfilled if the group performance indicator indicates that the at least one device parameter value of the patient group meets the at least one group target; and the feedback unit is further configured to provide a reward to the patient group if a group reward criterion is fulfilled.

As explained above for an individual reward, there may also be provided a group reward to the whole group. The joint effort of a group working together in order to obtain a reward may foster social interaction and further motivate all members of the group to contribute their share to reaching the group target.

According to yet another embodiment the target unit is configured to: determine or receive the at least one individual target along with information on an associated individual reward criterion and information on an associated individual reward; and/or determine or receive the at least one group target along with information on an associated group reward criterion and information on an associated group reward.

One possibility for the definition of the reward may be to associate a reward and a corresponding reward criterion with an individual or group target. This definition of the reward may particularly be provided by a physician or other medical support personnel along with the target itself. Alternatively, however, a reward (e.g. in the case the reward corresponds to a status posted to a social network profile of a patient) may also be calculated, i.e. determined, based on the current performance or based on the previous performance or on other information. It may, e.g., be possible that the reward criterion is increased on a daily or weekly basis, i.e. that every day the necessary effort for obtaining the reward is increased. An advantage of this embodiment is that no further information is required to determine the reward.

Alternatively or additionally, the target unit is configured to determine the at least one group target based on an average of at least one further individual target of the at least one further patient in the patient group; and/or the gamification unit is configured to determine the group performance indicator based on an average of at least one further individual performance indicator of the at least one further patient in the patient group.

On particularly useful approach for determining a group target is to calculate a group target based on the individual target of one or more patients in the patient group. Thus, no separate group target needs to be defined. An average may thereby refer to a weighted or arithmetic average. The average may be calculated based on the individual targets of all members or also based on the individual targets or one of the individual targets of only some members, e.g. the top 5 of a group of 10 or the like. On advantage is that it is not necessary to predetermine or pre-calculate a group target before the group is even formed. Making use of a simple average allows determining the group target based on the patients in the group without requiring any advance definition.

According to yet another embodiment the feedback unit is configured to provide the reward including a comparison of the individual performance indicator with: the group performance indicator; and/or at least one further individual performance indicator of at least one further patient, in particular at least one further individual performance indicator of the at least one further patient in the patient group.

It may be particularly advantageous to give an idea to a patient on how his therapy progresses in comparison with other patients in particular with other patients belonging to his patient group. Seeing that he is constantly outperformed may appeal to his ambition and may motivate him to increase his effort, i.e. therapy compliance.

### BRIEF DESCRIPTION OF THE DRAWINGS

These and other aspects of the invention will be apparent from and elucidated with reference to the embodiment(s) described hereinafter. In the following drawings

FIG. 1 shows a schematic illustration of a pressure support system in communication with an embodiment of a therapy support system according to the present invention;

FIG. 2 schematically illustrates the general information processing in a gamification unit in an embodiment of the therapy support system according to the present invention;

FIG. 3 schematically illustrates a plurality of patients interacting with an embodiment of the therapy support system according to the present invention;

FIG. 4 schematically illustrates the formation of a patient group and the interaction of said patient group with an embodiment of the system according to the present invention;

FIG. 5 schematically illustrates the information processing in a gamification unit of the system according to the present invention wherein also a reward is determined and provided to one or more patients;

FIG. 6 schematically illustrates the use of a plurality of sensors or sensing systems for obtaining sensor values indicative of device parameter values in communication with a therapy support system according to an embodiment of the present invention; and

FIG. 7 schematically illustrates the steps of an embodiment of a therapy support method for improving the compliance of a patient according to the present invention.

### DETAILED DESCRIPTION OF THE INVENTION

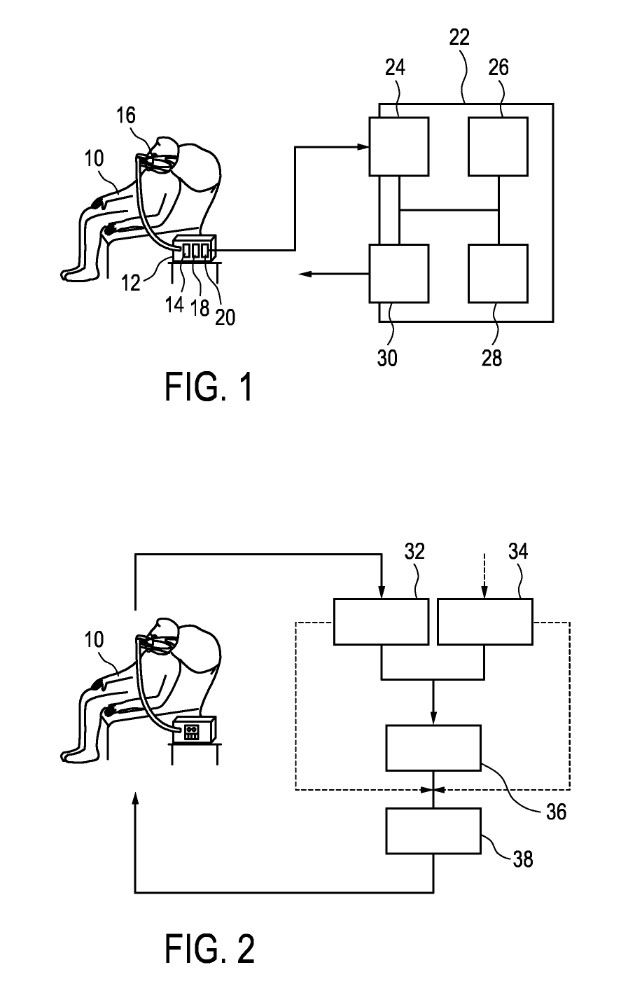

FIG. 1 shows a patient 10 using a therapeutic device 12. In order to explain and illustrate the present invention, the invention is explained and illustrated in the following figures based on a pressure support system representing the therapeutic device 12. The invention is, however not limited to this type of use but may also be applied in other fields such as diabetes therapy, fitness training, weight reduction or others.

A pressure support system 12, in particular a PAP machine, usually comprises a pressure generator 14, i.e. a pump, which generates a pressurized flow of breathable gas, in particular oxygen. This flow of pressurized breathable gas is delivered to the patient 10 via a patient interface 16. This patient interface 16 is particularly connected to the to the pressure generator 14 by means of a hose. In the illustrated example, the pressure support system 12 further comprises a sensor 18, which allows acquiring at least one device parameter value indicative of how the pressure support system 12 is used by the patient 10 (i.e. the patient's therapeutic device usage). Such a device parameter value that can be determined by means of a sensor 18 comprised in a pressure support system 12 could, e.g., include information on an apnea hypopnea index (AHI) of the patient 10, the provided pressure, the mask-wearing duration, the gas composition of the provided pressurized gas, the usage frequency, the usage time periods, the gas flow rate or the like. The device parameters may be indicated on an absolute scale or on a relative scale, time variant or time invariant, and may be determined constantly, on a regular basis (e.g. once per day, once per hour, etc.) or only occasionally (e.g. upon an externally provided trigger). It may also be possible that the patient himself or medical support personnel manually contribute device parameter values. Usually, therapeutic devices allow the person using the therapeutic device to select certain device settings. These may also be referred to as device parameter values.

According to the embodiment illustrated in FIG. 1, a device parameter value as determined by the sensor 18 included in the pressure support system 12 is provided via a therapy support system interface 20 comprised in the therapeutic device 12, to a therapy support system 22 for improving the compliance of a patient using a therapeutic device. This therapy support system 22 comprises a data interface 24 for receiving at least one device parameter value. Thereby, this at least one device parameter value may be received from a sensor in a therapeutic device 12 as illustrated in FIG. 1. It may, however, also be possible that the patient 10 himself or any medical support personnel provides at least one device parameter value. This provision may, e.g., work via an Internet interface such as a web front end of a web service or via a smartphone communicating wirelessly with a personal computer or also the keyboard or mouse interface of a personal computer.

The system 22 further comprises a target unit 26 for determining or receiving an individual target indicative of a targeted therapeutic device usage (corresponding to an intended or prescribed therapy). Such a target or objective may, e.g., directly correspond to a therapeutic device parameter value, such as wearing a patient interface for five hours, reaching a certain AHI, etc. This individual target may either be determined in the target unit 26 or may also be received from an external system, such as a medical database or (at least partly) be provided by medical support personnel in the form of a therapy plan or the like.

Still further, there is comprised a gamification unit 28 which includes the received device parameter value and the individual target in a game. In particular, the gamification unit 28 determines an individual performance indicator indicative of a success of the patient in reaching the individual target and determines feedback information including an assessment of the patient's perspective of reaching the individual target. Further details on the functioning of the gamification unit are given in the following based on the illustration in FIG. 2.

The system 22 further includes a feedback unit 30 for providing the feedback information to the patient 10. This feedback unit 30 may be represented by a graphical user interface such as a display or by a wired or wireless internet, network or other communication interface. The patient 10 may access a website that makes the feedback information accessible, receive a message (email, text message, social network communication, etc.) including the feedback information or even receive his feedback via an acoustic, haptic or other kind of interface.

In a preferable embodiment of the present invention, the data interface 24, target unit 26, gamification unit 28 and feedback unit 30 are basically implemented in software and included in an internet or network server and provide their functionality over the internet or over another network to a plurality of patients. Other embodiments such as the inclusion of some or all functionality in a personal computer, a smartphone app or in a therapeutic device may, however, also be possible. Depending on the application scenario the data interface 24, target unit 26, gamification unit 28 and feedback unit 30 comprised in a system according to the present invention may be included in separate or combined processing units such as a microprocessor, a field-programmable gate array, an application-specific integrated circuit or any other processing unit incorporating the described functionality. The units and interfaces may be partly or entirely implemented in soft- and hardware. In particular, the data interface 24 and the feedback unit 30 may be represented by a combined interface unit such as the wired or wireless network or internet connection or also a personnel computer for interacting with a processor device.

FIG. 2 further illustrates the information processing in an embodiment of a therapy support system according to the present invention with particular regard to the information processing in the gamification unit. A device parameter value 32 is received along with a corresponding individual target 34. In other embodiments of the present invention, it is also possible that the individual target 34 is determined within the therapy support system itself (e.g. based on an increase of a previous target or based on the patient's performance during the last day/week, etc.). It is to be understood that both the device parameter value 32 as well as the individual target 34 can also refer to multidimensional parameters including multiple values. It is also to be understood that multiple device parameter values 32 and multiple individual targets 34 can be received or determined.

As illustrated in FIG. 2, a performance indicator 36 is then calculated in the gamification unit 28 based on the device parameter value 32 and the individual target 34. Different possibilities for this performance indicator 36 exist. For instance, a percentage value may be calculated representing the share of the individual target 34 that is already completed. In a preferable embodiment, the performance indicator is calculated based on a difference between an individual target 34 and a corresponding device parameter value 32. If, e.g. the individual target 34 is to use a PAP machine for five hours and the device parameter value 32 indicates that the PAP machine has been used for three hours so far, the performance indicator 36 may particularly be calculated based on the difference of two hours between the two values. In this example, the performance indicator may then be represented by a percentage value (60%). The performance indicator may, however, also refer to a binary value indicating whether or not the patient has yet achieved the individual target, or to an absolute value on a predefined scale or other measures. Other examples for a performance indicator may also include a binary value representing whether or not the device parameter value 32 fulfills the individual target 34. Still further, a predefined or continuously updated absolute scale may be used for the performance indicator 36. The performance indicator 36 may also be calculated based on multiple individual targets 34 and device parameter values 32. For instance a weighted or arithmetic average of multiple percentage values representing the extent to which the multiple individual targets 34 are fulfilled may be calculated. It may also be possible that the calculation of the performance indicator 36 involves a look-up table operation in a predefined lookup table. The performance indicator 36 may represent a long or a short term performance depending on which individual targets 34 and device parameter values 32 are used as a basis and how it is calculated. The performance indicator 36 may also be represented by a multidimensional value. Other possibilities exist.

Based on the performance indicator 36, feedback information 38 is determined in the gamification unit 28. This feedback information 38 particularly includes an assessment of the first patient's perspective of reaching the individual target. In order to determine the feedback information 38, it may also be possible that the device parameter value 32 and/or the individual target 34 are also directly considered (in contrast to indirectly considering them by basing the feedback information 38 on the performance indicator 36), as illustrated in FIG. 2. Thus, the patient 10 may also obtain feedback information 38 including a therapeutic device parameter value 32 and/or an individual target 34.

Usually, determining the feedback information 38 in the gamification unit 28 thereby includes an arithmetic calculation that also considers a time-based component, i.e. the point in time at which the target has to be reached or the remaining time until the target has to be reached, is considered. For instance, in the above mentioned example wherein the performance indicator 36 indicates that the individual target 34 of five hours therapeutic device usage during one day is reached to 60%, the feedback information 38 may additionally consider that only four hours remain until midnight. The feedback information 38 may then either correspond to a qualitative statement such as an indication that the patient 10 should increase his effort or also a quantitative statement that the therapeutic device is to be used for two of the remaining four hours if the patient 10 wants to reach his individual target 34.

The feedback information 38 may also be calculated or determined, respectively, based on a mapping or lookup table operation of an individual performance parameter 36 in a predefined lookup table. The gamification unit 28 may be connected to a database in which a possible impact of a performance indicator 36 on the therapy of a patient (general impact on a therapy or individual impact on the patient's therapy) is stored. The feedback information 38 may correspond to a qualitative or quantitative statement, e.g. on a predefined numeric or other scale, or a combination thereof. Still further, the feedback information 38 may also include multiple values being indicative of the patient's perspective in reaching a short-term or long-term individual target 34. Depending on how the performance indicator 36 is calculated different other possibilities for determining the feedback information 38 exist.

The feedback information 38 is preferably provided (via the feedback unit 30) to the patient if an insufficient individual progress criterion is fulfilled. Such a criterion may, e.g., be represented by a threshold on the individual performance indicator 36. Thus, if the individual performance indicator 36 is below a predefined or constantly updated threshold (individual backlog threshold), this indicates that the patient 10 runs at risk of not reaching his individual target 34. The patient is therefore warned that he runs at risk of not reaching his individual target 34 if the feedback information 38 is only provided to him if such a criterion is fulfilled.

Getting back to the above mentioned example, the feedback information 38 may, e.g., be provided to the patient 10 if he has not completed 80% of his five hours of therapeutic device usage an two hours before the end of the day. Other possible criteria may include a performance value 36 that constantly has to be over a certain threshold (e.g. the pressure provided by a pressure support system needs to be higher than a predefined value).

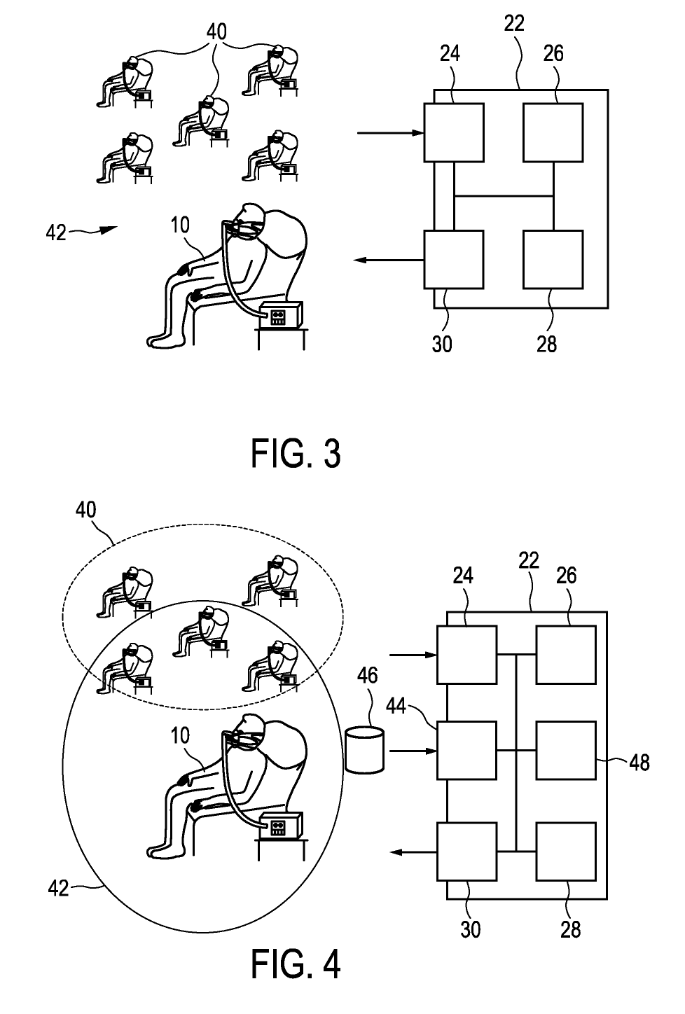

In another embodiment of the system 22 according to the present invention, as illustrated in FIG. 3, the data interface 24 is configured to further receive at least one device parameter value of at least one further patient 40 in addition to the at least one device parameter value of the patient 10. Further, the target unit 26 is configured to also determine or receive at least one group target in addition to the individual target as explained above. Thereby, a group target may particularly be calculated based on a plurality of individual targets by, e.g., averaging some or all of the individual targets. For instance, a group target may be represented by the average therapeutic device usage duration of all patients in a group. Other examples for group targets include a minimum usage intensity of all patients in a group, a minimum selected pressure of pressure support system used by the patients in a group, a cumulated usage time or intensity, an average usage time or intensity, etc. One group target may, e.g., be to achieve certain an average AHI in the patient group. If on patient deviates from this AHI too much, the other patients in the patient group may realize this and interact with the patient to motivate him to increase his AHI by using his PAP device more regularly. Another example for a group target may, e.g., be that all patients in the patient group have to reach a certain minimum AHI and it is not possible to compensate an underperformance of one patient in the group by another patient that overperforms.

All patients 40 (e.g. all patients participating in an internet-based or web service-based embodiment of the present invention) contribute their device parameter values to the system 22 via the data interface 24.

Based on the determined or received at least one group target, the gamification unit 28 then determines a group performance indicator in addition to the individual performance indicator. This group performance indicator may be determined analogously to the individual performance indicator by comparing the at least one device parameter value of the at least one further patient 40 with the at least one group target. For instance, a group performance indicator may be indicated on a percentage scale indicating the deviation or difference between the average times the patients 40 use their therapeutic devices from the targeted average usage time as indicated by a corresponding group target. The feedback information 38 determined in the gamification unit 28 then also includes an assessment of the patient groups 42 perspective of reaching the at least one group target. The patient group 42 includes the at least one further patient 40 and the patient 10. It may then be possible that the feedback unit 30 provided the feedback only to the patient 10 or also to the at least one further patient 40. All or part of the feedback information 38 may be provided to at least one further patient 40 in order to foster social interaction between the at least one further patient 40 and the patient 10 and thereby increase motivation. By providing the feedback information 38 not only to the patient but also to at least one further patient 40, mutual help and assistance within the group could be achieved.

FIG. 4 illustrates yet another embodiment of a system 22 according to the present invention. In addition to a data interface 24, a target unit 26, a gamification unit 28 and a feedback unit 30 as explained above, the system 22 further includes a medical database interface 44 which may, e.g., be connected to a medical database 46 or the like and which is configured to obtain profile data of the patient 10 and the at least one further patient 40. Such profile data may particularly include information on at least one of medical history, therapeutic device usage period, medication, age, weight, height, and sex. The profile data may also include further information describing what type of therapeutic device a patient uses.

The system 22 further comprises a group determination unit 48 in which, based on the profile data, a patient group 42 is determined. Thus, a group of patients with similar profiles, demographic or therapeutic device start data is determined. For instance, a patient group 42 may be determined by determining all patients that use the same type of PAP machine and that initially start their therapy during one particular week. Another example may be to include all male patients in the age from 40 to 50 into one patient group. Depending on how the patient group 42 is formed, i.e. based on which criteria, it may make sense to define the group target accordingly. It may, e.g., not make sense to define a group target of reaching a certain minimum AHI, if it is clear that one patient in the patient group has been suffering from heavy obstructive sleep apnea for the last ten years and has never even come close to this AHI whereas all other patients in the group only suffer from a moderate OSA and will easily reach this AHI.

Further, by including patients with comparable profile data into one patient group 42, the comparability can be assured and it may be assured that a meaningful group target can be defined for the patient group. The illustrated embodiment of the system 22 allows determining such a meaningful patient group 42. By establishing communication among this patient group 42, social interaction may be fostered. If, e.g., feedback information 38 is communicated via the feedback unit 30 to the patient group 42, e.g. including patients that have started their therapy at the same date with a comparable or similar therapeutic device, these patients may feel a sense of belonging to the patient group 42, which may increase their motivation to contribute to reaching their at least one group target.

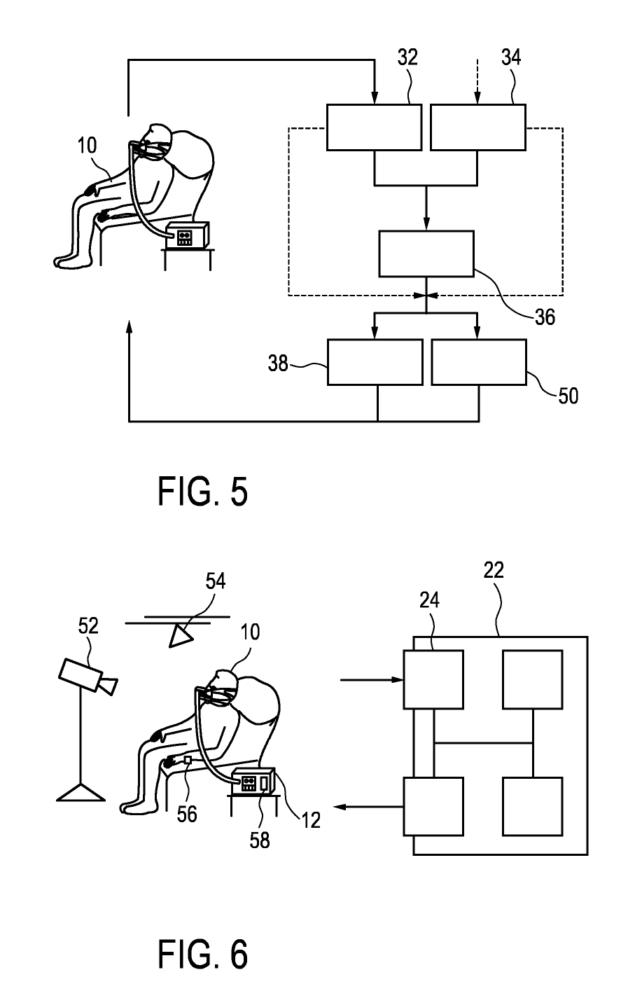

FIG. 5 illustrates yet another possibility for the information processing in the gamification unit according to another embodiment of a system according to the present invention. Again, at least one device parameter value 32 and at least one individual target 34 are fed into the gamification unit and a performance indicator 36 is calculated based thereupon. As explained above, feedback information 38 is determined and provided to the patient 10. However, the gamification unit is this time configured to determine, whether an individual reward criterion is fulfilled. If this is the case, an individual reward 50 can also be provided to the patient 10 along with the feedback information 38. Such an individual reward 50 may, e.g., correspond to a text message, which is sent to a relative or a friend of the patient, a relieve in therapy, such as a reduction in PAP pressure, access to additional functionality of the therapeutic device (PAP device features), or in a status (e.g. silver, gold or platinum status) added to a patient's 10 social network profile. Depending on the personality of the patient the perspective of obtaining such a reward 50 may additionally increase his motivation to comply with his prescribed therapy as defined by his individual targets 34.

The determined reward 50 may particularly be provided to the patient 10 if the individual performance indicator 36 indicates that the at least one device parameter value 32 meets the at least one individual target 34. The determination of the reward 50 may particularly be based on a reward database which associates a specific individual target 34 with an individual reward criterion that has to be met in order to earn the reward 50 and with information on an associated individual reward 50, i.e. information on the reward 50 itself (i.e. which type of reward is to be provided if this particular individual target is reached).

In further embodiments, it may also be possible that not only an individual reward 50 is determined but that also a group reward is determined analogously based on a group device parameter and a group target. This group reward may then be provided to the patient group 42. If a patient group 42 is considered, a reward may particularly include a comparison of a patient and his performance indicator with the performance indicators of other patients in the patient group. Providing rewards to patients or to the patient group 42 may further increase the motivation of the patients to comply with their therapy as represented by their individual or group targets. A group reward may cause a team spirit, among the patients in the patient group 42 and thereby result in an increased motivation.

FIG. 6 illustrates different possibilities for obtaining device parameter values for a patient 10. These device parameter values are then received in an embodiment 22 of a therapy support system according to the present invention via the data interface 24.

Device parameter values may, e.g., be determined by means of a camera sensor 52 configured to obtain images of the patient 10 and determine therefrom vital sign information (remote photoplethysmography), information on the sleep quality of the patient (e.g. based on an evaluation of the patient's movements during a night), an evaluation of the eye movements of a patient, etc. It may also be possible that an acoustic sensor 54 is used for monitoring e.g. the snoring sounds or other noises emitted by the patient 10. Based upon such information of an acoustic sensor 54, it may, e.g., be determined how well a patient slept, how much he moved during the night, how often and how long he was awake, etc. It may also be possible that a sensor device 56 is directly attached to the patient 10 and provides information such as an acceleration signal, a photoplethysmography signal, or the like, that can be used in order to obtain information on the patient's 10 sleep quality.

Still further, it may be possible that a sensor device 58 is directly integrated with the therapeutic device 12 the patient 10 uses. This sensor device 58 may preferably be in direct communication with the system 22, e.g. via the internet. Such an integrated sensor device may provide information on the therapeutic device settings chosen by the user as well as on the therapy delivered by the therapeutic device as outlined above. For instance, a PAP device may communicate the time periods it was used, an estimated AHI of the patient (most current PAP machines incorporate an estimation of the AHI, e.g. based on an evaluation of the respiratory flow), the provided gas composition and flow rate, etc.

The information collected by the sensors 52, 54, 56 and 58 can also be preprocessed prior to be communicated to the system 22. Thereby, the communication may be direct via any wired or wireless interface or indirect via an intermediate system such as a network or the Internet. It may also be possible that device parameter values are determined based upon the acquired sensor information.

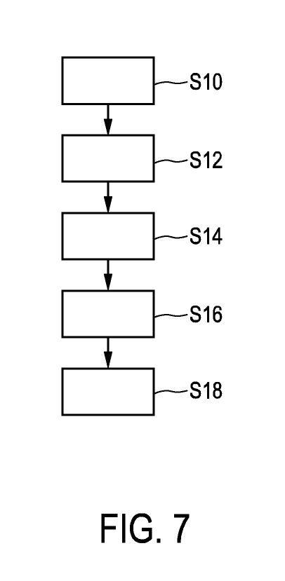

In FIG. 7 a therapy support method according to an aspect of the present invention is illustrated. Said method comprises the steps of receiving at least one device parameter value (step S10), determining or receiving at least one individual target (step S12), determining an individual performance indicator (step S14), determining feedback information (step S16) and providing the feedback information to the patient (step S18).

The method according to the present invention may, e.g., be carried out in an Internet-based system, on a personal computer or on a personal information device such as a smartphone or tablet. It may also be possible that some of the steps of the method are carried out on one of an internet server, a personal computer, a personal information device, and other steps of the method are carried out on another one of an internet server, a personal computer or a personal information device.

According to a preferable embodiment, the illustrated method is carried out on a web- or a hospital server which is accessible for a plurality of patients.

One particular use case or application scenario is described in the following for PAP device users (patients): patient A wears a patient interface for the first time. An individual target of wearing the patient interface for five hours on the first night is provided by patient A's physician. Then patient A is introduced (virtually) to a group of people who share his situation (further patients) and a patient group is formed (including patient A and the further patients).

With the individual target, there is associated a reward criterion, which corresponds to completing a bar representing 10% of the individual target. Also, a reward is associated with the individual target which corresponds to a text message sent to one of the patients grandchildren. If the patient achieves his individual target the reward is provided.

Further, the patient's status is updated so it can be observed by the other patients in the patient group. The patient can then see that he is in the top 25th percentile of his patient group. He can also see that patient B, who is also in the patient group, only managed two hours in the last night. If there is then also defined a group target corresponding to everyone in the group managing at least three hours of PAP device usage, patient A will know that without everyone in his group managing three hours they will not be able to obtain a group reward. Accordingly, patient A will communicate with patient B and encourage/motivate him and/or try to help him with and help with a possible problem.

On the next day, patient A is then set a target of wearing the patient interface for seven hours. He, however, removes the patient interface after six hours. Immediately, feedback information is provided to patient A and to the other patients in the patient group (insufficient individual progress criterion is fulfilled and/or insufficient group progress criterion is fulfilled), such that the patients in the patient group see that for the next day this will likely result in patient A not receiving his individual reward, being in the bottom 25th percentile of his patient group, and the patient group being likely to not receiving the group reward for that day. The patient will then likely put his patient interface back on. When he checks on his individual and/or group performance the next time, he will see that he is on a good way to reach the target and also see how his peers (other patients in the patient group).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Therapy support system for improving the compliance of a patient using a therapeutic device, comprising:
a data interface for receiving at least one device parameter value of a first patient indicative of a therapeutic device usage of the first patient;
a target unit for determining or receiving at least one individual target indicative of a targeted therapeutic device usage of the first patient;
a gamification unit for determining an individual performance indicator based on the at least one device parameter value and the at least one individual target, said individual performance indicator being indicative of a success of the first patient in reaching the at least one individual target, said gamification unit being further configured to determine based on said individual performance indicator (36) feedback information including an assessment of the first patient's perspective of reaching the at least one individual target; and
a feedback unit for providing the feedback information to the first patient.

2. Therapy support system as claimed in claim 1, wherein:
the data interface is configured to further receive at least one device parameter value of at least one further patient;
the target unit is configured to further determine or receive at least one group target indicative of a targeted therapeutic device usage of a patient group including the first patient and at least one of the at least one further patient;
the gamification unit is configured to further determine a group performance indicator based on the at least one device parameter value of the patient group and the at least one group target, said group performance indicator being indicative of a success of the patient group in reaching the at least one group target; and
the feedback information further includes an assessment of the patient group's perspective of reaching the at least one group target based on the group performance indicator.

3. Therapy support system according to claim 2, further comprising:
a medical database interface for obtaining profile data of the first patient and the at least one further patient, said profile data including information on at least one of medical history, therapeutic device usage period, medication, age, weight, height and sex of said patients;
a group determination unit for determining the patient group based on a comparison of the profile data of the first patient with the profile data of the at least one further patient.

4. Therapy support system as claimed in claim 1, wherein the gamification unit is configured to determine the individual performance indicator based on:
a difference between the at least one device parameter value and the at least one individual target;
a function of said difference; or
a look-up table including individual performance indicators for different values of said difference.

5. Therapy support system as claimed in claim 1, wherein
the gamification unit is further configured to determine if an insufficient individual progress criterion is fulfilled, said insufficient individual progress criterion particularly being fulfilled if the individual performance indicator is below a tolerable individual backlog threshold; and
the feedback unit is configured to provide the feedback information to the first patient and/or to at least one further patient if the insufficient individual progress criterion is fulfilled.

6. Therapy support system as claimed in claim 2, wherein the feedback unit is configured to further provide at least part of the feedback information to the patient group.

7. Therapy support system as claimed in claim 2, wherein
the gamification unit is further configured to determine whether an insufficient group progress criterion is fulfilled, said insufficient group progress criterion particularly being fulfilled if the group performance indicator is below a tolerable group backlog threshold; and
the feedback unit is configured to provide the feedback information to the first patient and/or to provide at least part of the feedback information to the patient group if the insufficient group progress criterion is fulfilled.

8. Therapy support system as claimed in claim 1, wherein:
the gamification unit is further configured to determine whether an individual reward criterion is fulfilled, said individual reward criterion particularly being fulfilled if the individual performance indicator indicates that the at least one device parameter value meets the at least one individual target; and
the feedback unit is further configured to provide a reward to the first patient if the individual reward criterion is fulfilled.

9. Therapy support system as claimed in claim 2, wherein:
the gamification unit is further configured to determine whether a group reward criterion is fulfilled, said group reward criterion particularly being fulfilled if the group performance indicator indicates that the at least one device parameter value of the patient group meets the at least one group target; and
the feedback unit is further configured to provide a reward to the patient group if a group reward criterion is fulfilled.

10. Therapy support system as claimed in claim 2, wherein the target unit is configured to
determine or receive the at least one individual target along with information on an associated individual reward criterion and information on an associated individual reward; and/or
determine or receive the at least one group target along with information on an associated group reward criterion and information on an associated group reward.

11. Therapy support system as claimed in claim 2, wherein:
the target unit is configured to determine the at least one group target based on an average of at least one further individual target of the at least one further patient in the patient group; and/or
the gamification unit is configured to determine the group performance indicator based on an average of at least one further individual performance indicator of the at least one further patient in the patient group.

12. Therapy support system as claimed in claims 2 and 8, wherein the feedback unit is configured to provide the reward including a comparison of the individual performance indicator with:
the group performance indicator; and/or
at least one further individual performance indicator of at least one further patient, in particular at least one further individual performance indicator of the at least one further patient in the patient group.

13. Pressure support system comprising:
a pressure generator for generating a pressurized flow of breathable gas;
a patient interface for delivering the pressurized flow of breathable gas to the patient;
a sensor for acquiring a device parameter value; and
a therapy support system interface for providing the device parameter value to a therapy support system as claimed in claim 1.

14. Therapy support method for improving the compliance of a patient using a therapeutic device, comprising the steps of:
receiving at least one device parameter value of a first patient indicative of a therapeutic device usage of the first patient;
determining or receiving at least one individual target indicative of a targeted therapeutic device usage of the first patient;
determining an individual performance indicator based on the at least one device parameter value and the at least one individual target, said individual performance indicator being indicative of a success of the first patient in reaching the at least one individual target;
determining based on said individual performance indicator feedback information including an assessment of the first patient's perspective of reaching the at least one individual target; and
providing the feedback information to the first patient.

15. Computer program comprising program code means for causing a computer to carry out the steps of the method as claimed in claim 14 when said computer program is carried out on the computer.
